(19) United States
(12) Patent Application Publication
(10) Pub. No.: US 2013/0008034 A1
(43) Pub. Date: Jan. 10, 2013

(54) KITCHEN UTENSIL

(75) Inventors: Scott Mizer, Cleveland, OH (US); Terry Hua, Broadview Heights, OH (US); Cherry Bochmann, Bay Village, OH (US); Erin Riddell, Bay Village, OH (US)

(73) Assignee: Pragotrade, Inc., Strongsville, OH (US)

(21) Appl. No.: 13/176,379

(22) Filed: Jul. 5, 2011

(51) Int. Cl. B26B 13/00

(52) U.S. Cl. 30/279.2

(57) ABSTRACT

A kitchen utensil including a cutter rotatably mounted between a pair of handles, the cutter having plural circumferential cutting edges, and at least one longitudinally extending blade removably attached to the barrel forming a longitudinal cutting edge. The kitchen utensil may include a sleeve that fits over the cutter to allow the kitchen utensil to be used as a rolling pin.

### TECHNICAL FIELD

In general, the present invention relates to manually operated kitchen utensils. In particular, the present invention relates to a combination ravioli cutter and rolling pin. Most particularly, the present invention relates to a ravioli cutter drum that is mounted between a pair of handles, where the drum rotates relative to the handles, and a sleeve that fits over the drum and may be fixed relative to the handles to operate as a rolling pin.

### BACKGROUND OF THE INVENTION

U.S. Pat. No. 3,186,362 discloses a rapid ravioli maker that includes a ravioli cutter in the form of a drum with multiple cavities formed thereon to shape pasta dough and filling and outwardly projecting edges that cut the shaped dough and filling into ravioli as the drum is rolled along the layers of pasta dough and filling. To facilitate rolling of the drum, a pair of handles are journaled on rods extended from either end of the drum.

Although the rapid ravioli maker patent issued in June of 1965, there has been little, if any, evolution in its design. The shapes of the cavities and cutting blades have varied to an extent to form more decorative ravioli, but no true functional improvements have been made. For instance, to form the ravioli shapes, multiple discreet cavities are formed on the drum of the rapid ravioli cutter that include high included angles between the drum and the cutting edges that extend from it. As a result, these surfaces are difficult to clean. Therefore, a need exists for a drum for a rapid ravioli cutter that is easier to clean.

Also, when preparing pasta dough and filling, the dough needs to be rolled out into a sheet-like layer. Typically, a large sheet is rolled out with a rolling pin before applying filling to one side of the rolled out sheet. The uncovered portion of the sheet is then folded over the filling and the sides sealed by pressing them together in preparation for rolling the rapid ravioli cutter over the dough to cut ravioli from the sheets of dough and filling material. The practical consequence is that two fairly bulky kitchen utensils are needed, namely, a rolling pin and a ravioli cutter. In most homes, kitchen space is at a premium. Therefore, a need exists for a kitchen utensil that combines the rolling pin and ravioli cutting functions.

### SUMMARY OF THE INVENTION

The present invention provides a drum for a rolling ravioli cutter that has a removable longitudinally extending blade. The present invention further provides a method for cleaning the kitchen utensil by removing a longitudinally extending blade from the drum before washing the drum.

The present invention further provides a ravioli cutter and rolling pin combination including a sleeve that fits over the ravioli cutter and is fixed relative to the handles such that it may be used as a rolling pin and removed to cut ravioli.

### FIGURE DESCRIPTIONS

FIG. 1 is a perspective view of a kitchen utensil according to the concepts of the present invention;

FIG. 2 is an end elevational view of the kitchen utensil shown in FIG. 1;

FIG. 3 is a sectional side elevational view of the kitchen utensil shown in FIG. 1 as might be seen along line 3-3 in FIG. 2;

FIG. 3A is an enlarged sectional view of an end of the kitchen utensil indicated in FIG. 3;

FIG. 4 is a perspective view similar to FIG. 1 with the cover and end caps removed;

FIG. 5 is an exploded perspective view of the kitchen utensil shown in FIG. 4;

FIG. 6 is an exploded perspective view of the kitchen utensil shown in FIG. 1.

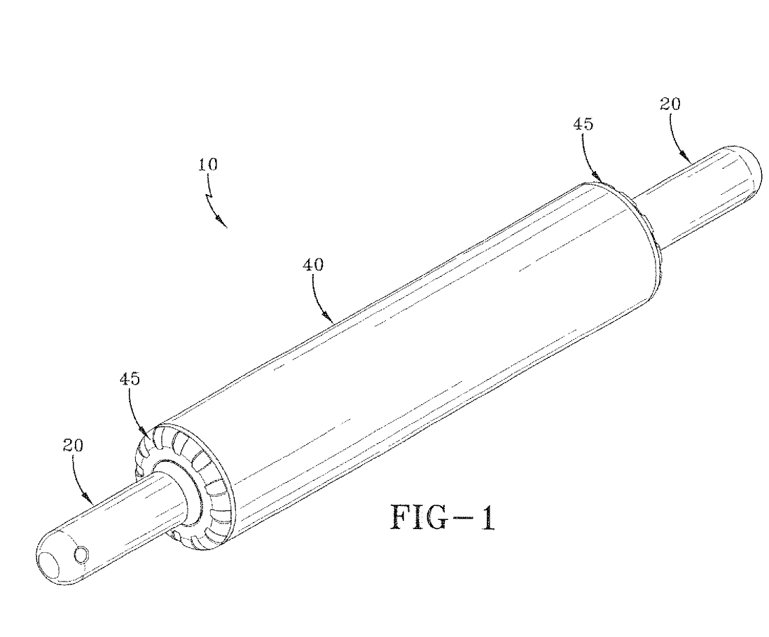

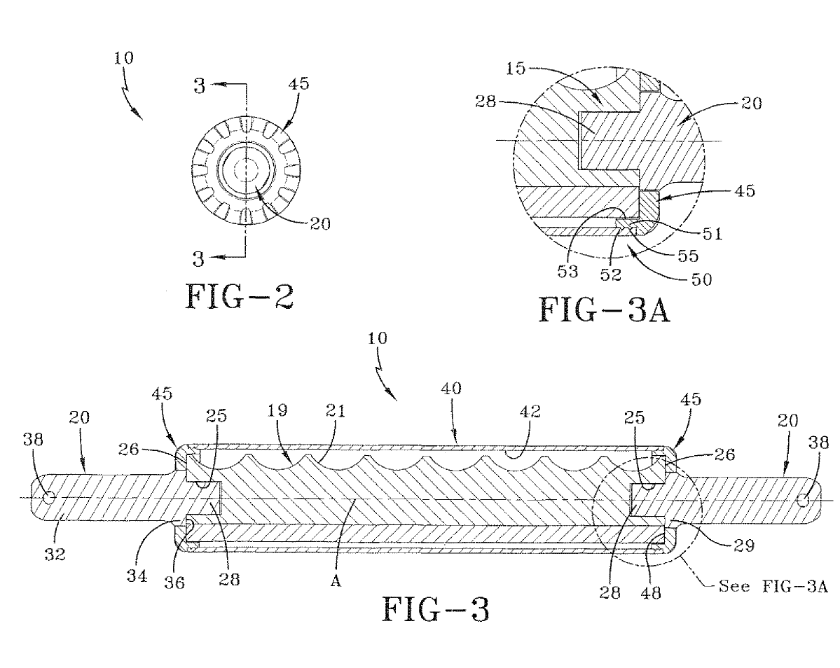

### DETAILED DESCRIPTION OF THE INVENTION

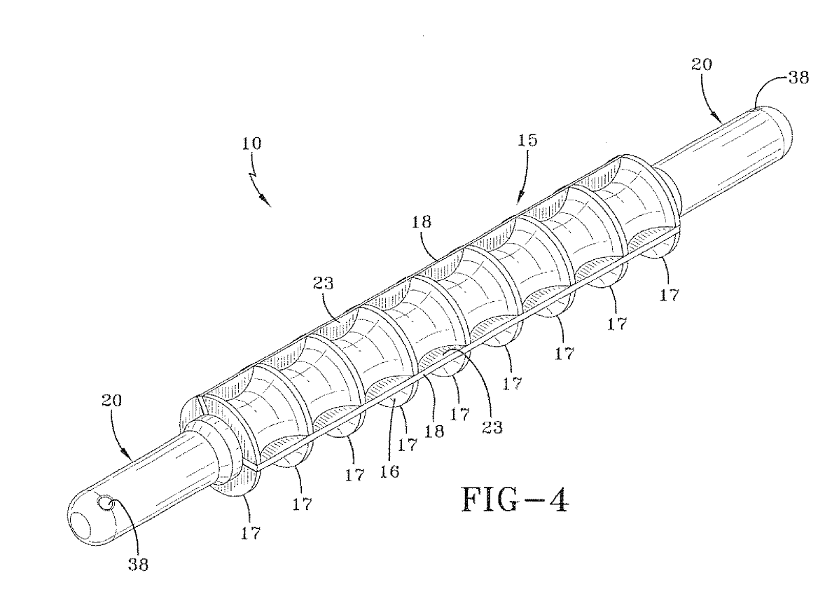

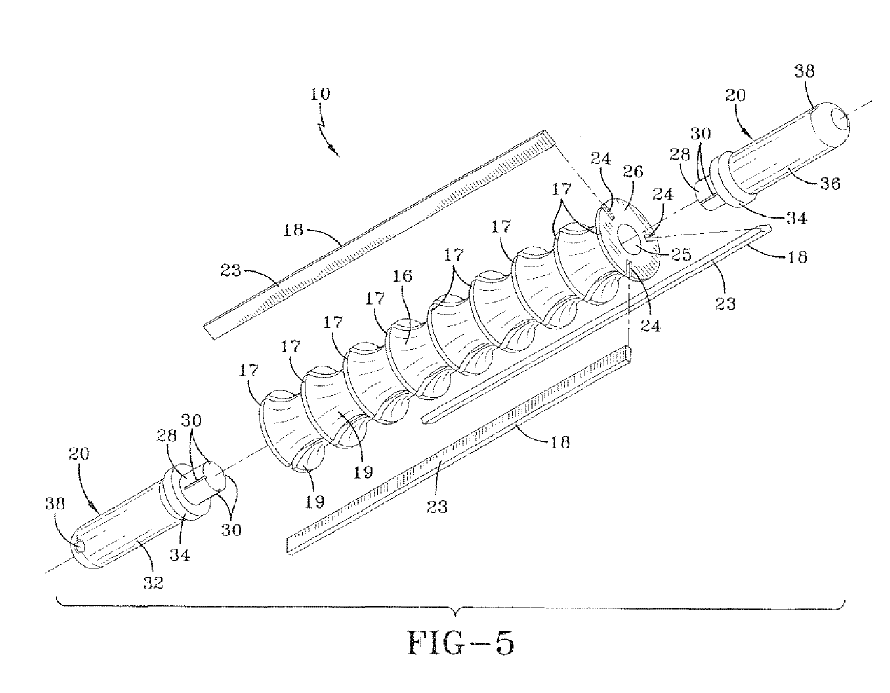

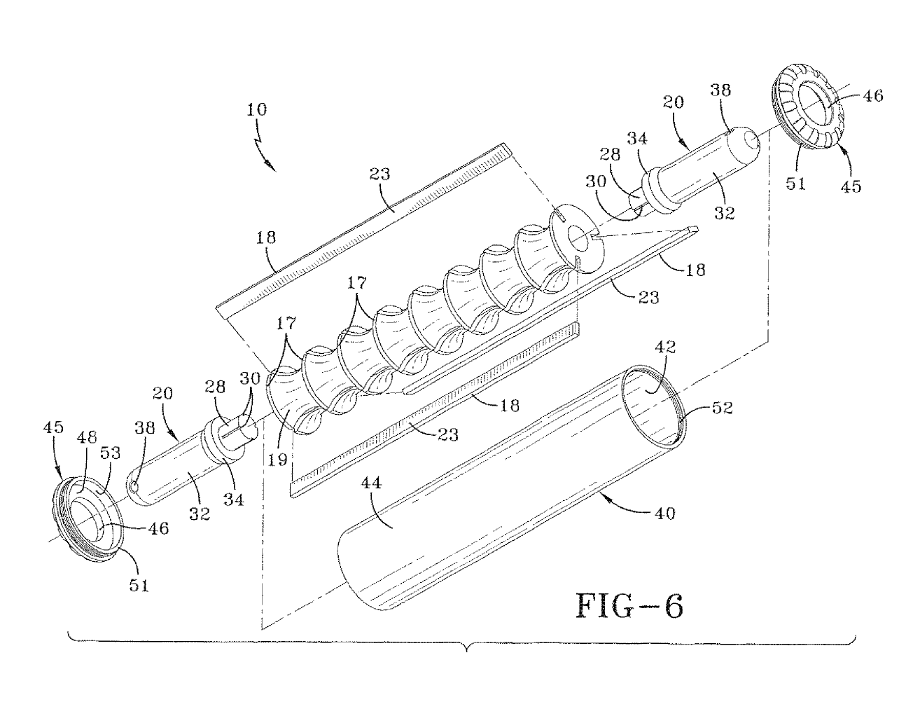

A kitchen utensil, generally indicated by the number 10 is shown in the accompanying drawings. With reference to FIG. 4, kitchen utensil 10 may include a ravioli cutter or similar device used to emboss or cut a rolled sheet of dough or other material used in cooking. For simplicity, these devices will be collectively referred to as a cutler and generally indicated by the number 15.

Cutter 15 generally includes a body having outwardly extending cutting or embossing surfaces that are rolled over a rolled out sheet of dough to cut or emboss the dough to form a desired shape. Cutting ravioli is one practical use for a cutter 15 of this type. While the discussion herein focuses on a ravioli cutter, this discussion merely provides one example, and it will be appreciated that a rolling cutter 15 may be configured for other cutting and embossing applications.

In the example shown, cutter 15 includes a barrel or drum 16 that is rotatably mounted between a pair of handles 20. In the example shown, barrel 16 includes plural circumferential cutting edges 17 disposed along the length of barrel 16 at spaced intervals. As best shown in FIG. 6, the areas between circumferential edges 17 may be recessed to form circumferential troughs 19 between each circumferential edge 17. The troughs 19 may have any cross section including the semi-circular cross section best seen in FIG. 3. To that end, barrel 16 may include a semi-circular inwardly extending surface 21 extending longitudinally between each circumferential edge 17. Other cross sections and surface treatments may be used to further emboss or shape the dough as barrel 16 is rolled over it.

Cutter 15 further includes one or more longitudinal cutting edges 18 that intersect with circumferential cutting edges 17 to define shape forms there between for the cutting or embossing of cooking materials such as dough and fillings used to make cooking products like ravioli. In the example shown, three longitudinal cutting edges 18 are provided to define three rows of cooking shape forms. With reference to FIG. 6, longitudinal cutting edges 18 may be formed by removable blades 23 that slide into a longitudinally extending recess 24 defined in barrel 16. In the example shown, the blades 23 are rectangular in shape and fit into generally rectangular cross-sectioned recesses 24 formed in barrel 16. As best seen in FIG. 6, the contour of the barrel 16 causes the recess 24 to vary to some extent in height, such that the cross-section of the recess 24 is not constant along the entire length L of the barrel 16. Removable attachment of blade 23 may be accomplished in a number of manners, including the use of removable fasteners such as clips, tabs, detents, or traditional fasteners including screws, etc. Alternatively, as shown, the cross-section of recesses 24 may be sized closely to or slightly smaller than the cross-section of blade 23 to create an interference fit between the blade 23 and the walls of recess 24. Allowing removal of blade 23 greatly improves existing designs that use fixed blades in that the circumferential troughs 19 formed between circumferential edges 17 are opened, making it easier to clean these areas and remove any dough that may have been compressed against the edges 18 on the blade 23 or potentially seeping into recess 24 during the rolling process. Alternatively, blades 23 may be integrally formed or molded with barrel 16 or fixed by an adhesive, weld, or other fastener.

With reference to FIG. 3, handles 20 may be attached to cutter 15 at a central location and lie along the center axis A of cutter 15. Handles 20 are attached to cutter 15 to allow rotation of cutter 15 relative to the handles 20. To that end, any type of attachment that allows such rotation would be suitable for attaching the cutter 15 to handles 20 including the use of pins extending from cutter 15 and other similar arrangements. In the example shown, cutter 15 has handle recesses 25 extending axially inward from each outer end 26 of barrel 16. Handle 20 may include an inwardly projecting boss 28 that fits into handle recess 25. Boss 28 may simply be an extension of handle 20 or have a different diameter or cross-section than handle 20. In the example shown, boss 28 is generally circular in cross-section and has a smaller diameter than the handle 20. Each boss 28 may be journaled within recess 25 to allow the barrel 16 to rotate on bosses 28 between handles 20. To that end, raceways or notches 30 may be formed in boss 28 to accommodate suitable rolling bearing elements. For example, elongate notches may receive needle bearings (not shown) to facilitate rotation of cutter 15 relative to handles 20. Alternatively, as shown, handles 20 may be rotationally fixed relative to cutter 15 causing the cutter 15 and handles 20 to rotate together. In the example shown, notches 30 are formed in bosses 28 of handles 20 and receive corresponding tabs (not shown) extending inwardly into handle recesses 25 to rotationally fix handles 20 relative 15. In operation, the user would loosely grip the handles and allow them to rotate within their hands as they roll cutter 15 over the dough.

The handle 20 may have any shape or cross-section. In the example shown, the cross-section of the handle 20 is generally circular and may include a cylindrical grip portion 32 extending outwardly from a tang 34 formed adjacent to the boss 28. Tang 34 has a larger diameter than both the boss 28 and grip portion 32 to guard the user's hands from coming in contact with cutter 15. The inwardly facing surface 36 of tang 34 that is exposed adjacent to boss 28 may contact the outer end 26 of barrel 16. It will be appreciated that the tang 34 is optional and the handle 20 may have a uniform diameter across its length. As a further option, as shown, an opening 38 may be provided in handle 20 to facilitate storage, as by hanging the handle by a loop or hook inserted through the opening 38.

According to another aspect of the present invention, a sleeve is provided to allow use of the kitchen utensil 10 as both a cutter and a rolling pin. Sleeve 40 may be cylindrical in shape defining a bore 42 sized to receive outer 15 therein. To facilitate rolling of dough or other cooking material, the outer surface 44 of Sleeve 40 may be smooth and have a circular cross-section. Sleeve 40 may be held by one or more end caps, generally indicated by the number 45, to prevent the sleeve 40 from moving axially when used as a rolling pin. End cap 45 may be any member that axially restricts movement of the sleeve 40 once it is positioned over cutter 15. It will be appreciated that a single end cap 45 may be used for this purpose, leaving the opposite end of sleeve 40 open. Alternatively, as shown, a pair of end caps 45 may be used to secure both ends of sleeve 40 from axial movement. Each end cap 45 may define a central opening 46 that allows the end cap 45 to fit over the handle 20. In the example shown, the sleeve 40 is not rotationally fixed to cutter 15 or handles 20 and is free to rotate independently of cutter 15 or handles 20. In this way, handles 20 may be held by the user and the sleeve 40 rolled over the dough or other cooking material as one would use an ordinary rolling pin. As discussed above, the attachment of end caps 45 restrict axial movement of sleeve 40 so that it covers cutter 15. In the example shown, the inner surface 48 of end cap 45 may butt against the outer end 26 of barrel 16. It will be appreciated that some gap between the end caps 45 and barrel 16 may be permitted which would allow the sleeve 40 to move a slight distance in the axial direction without disrupting use of sleeve 40 as a rolling pin.

To secure the sleeve 40 to each end cap 45, a fastener, generally indicated by the number 50 may be provided. Any fastener that allows the sleeve 40 to selectively be attached and removed from end cap 45 is suitable. For example, pins, screws, and other traditional mechanical fasteners could be used. In the example shown, fastener 50 includes a threaded flange 51 extending inward from end cap 45 received within an internally threaded portion 52 of sleeve 40. Flange 51 extends inwardly from end cap 45 may be formed integrally with end cap 45, as shown, or as a separate member that is attached to end cap 45. Similarly, the internally threaded portion 52 may, as shown, be formed integrally with sleeve 40, but it will be appreciated that an internally threaded receiver may be attached to the sleeve 40 to serve the same purpose.

Returning to the example shown in FIG. 3, flange 51 is cylindrical in shape and has an inner surface that defines a cutter opening 53 adapted to receive a portion of the cutter 15 therein. It will be appreciated that cutter opening 53 may be larger than the diameter of the cutter 15. When assembled, a portion of cutter 15 is received within cutter openings 53 at opposite ends of the sleeve 40 such that the cutter 15 is captured between end caps 45 and the sleeve, which is attached to end caps 45, is thereby prevented from moving axially. In effect, each end cap 45 acts as a stop to any axial movement of sleeve 40.

As discussed, the outer surface of flange 51 carries threads 55 that are received within the internal threads 56 formed on sleeve 40. In terms of assembly, to use utensil 10 as a rolling pin, at least one end cap 45 must be removed from sleeve 40 to allow it to slide over a handle 20 and cutter 15. Then, to secure sleeve 40 relative to cutter 15, the second end cap 45 is slid over the opposite handle 20 and attached to sleeve 40 with fastener 50. Therefore, it will be appreciated that one end cap 45 may be permanently affixed to sleeve 40. In the example shown, however, both end caps 45 are removable from sleeve 40 by a releasable fastener 50. This optional assembly may facilitate cleaning of the interior of the sleeve 40.

Once the sleeve 40 is attached, kitchen utensil 10 may be operated as a traditional rolling pin by holding the handles 20 and rolling the sleeve 40 over the dough or other cooking material. Once the dough is rolled out, sleeve 40 may be removed by unfastening one of the end caps 45 and sliding sleeve 40 over handle 20 to expose cutter 15. At this point, cutter 15 may be rolled over the dough to emboss or cut the dough in a desired fashion. For example, in the embodiment shown, cutter 15 is configured to form ravioli. Therefore, cutter 15 may be rolled over a layer of filling sandwiched between two layers of rolled out pasta dough to form multiple ravioli defined by the cavities between the circumferential and longitudinal cutting edges 17, 18.

As noted above, the blades 23 forming longitudinal cutting edges 18 may be removed for cleaning. Alternatively, alternate blades 23 having a different configuration or surface may be substituted to create a different cutting effect. For example, blades 23 may have stepped surfaces between the circumferential cutting edges 17 to form a jagged edge on each ravioli. Similar variations in the circumferential edges 17 may be used as well. The removable nature of blades 23 is believed to improve upon existing ravioli cutters in that it provides greater flexibility to the user in terms of ornamenting the ravioli cut by cutters 15 without the need to replace the entire barrel 16.

The components of kitchen utensil 10 may be constructed of any suitable material, commonly found in kitchen utensils including, but not limited to, wood, plastic, ceramics, metals and combinations thereof. In the example shown, the components are constructed of plastic.

It will be understood that although specific embodiments have been presently disclosed herein, various modifications and substitutions may be made to the described embodiments without departing from the scope of the invention. Therefore, for an appreciation of the scope of the invention, reference should be made to the following claims.

1. A kitchen utensil comprising: a cutter rotatably mounted between a pair of handles, said cutter having plural circumferential cutting edges spaced from each other and at least one longitudinally extending blade removably attached to said cutter forming a longitudinal cutting edge.

2. The kitchen utensil of claim 1, wherein each circumferential edge defines a blade receiving recess and wherein said longitudinal blade is slidably received radially within said blade receiving recesses in said circumferential edges.

3. The kitchen utensil of claim 2, wherein said blade recesses have a cross-section adapted to form an interference fit when said blade is inserted within said blade recesses.

4. The kitchen utensil of claim 1 further comprising a sleeve defining a bore adapted to receive said cutter therein, said sleeve having at least one end cap removably attached thereto, said end cap defining a central opening through which one of said handles is received; and a fastener attaching said end cap to said sleeve.

5. The kitchen utensil of claim 4, wherein said fastener includes an internal thread formed within said sleeve about a portion of said bore and an external thread carried on said end cap.

6. The kitchen utensil of claim 1 further comprising a sleeve defining a bore adapted to receive said barrel therein; a first end cap and a second end cap defining a central opening adapted to receive a handle there through; and a pair of fasteners each attaching one of said end caps to said sleeve at opposite ends of said barrel.

7. The kitchen utensil of claim 6, wherein said fastener includes a flange extending inwardly from each end cap having an external thread and an internal thread formed on said sleeve and opening into said bore to threadably receive said flange extending inward from said end cap.

8. The kitchen utensil of claim 1, wherein each end of said cutter defines an inward extending handle recess, each of said handles is received in each of said handle recesses.

9. The kitchen utensil of claim 8, wherein each handle includes an axially inward extending boss, each of said bosses being rotatably fixed relative to said cutter.

10. A kitchen utensil comprising a pair of handles aligned along an axis; a cutter supported between said handles and rotatable about said axis; a sleeve defining a bore adapted to receive said cutter; an end cap attached to one end of said sleeve, said end cap defining an opening through which one of said handles extends; a second end cap removably attached to said sleeve by a fastener, said second end cap defining an opening through which said handle is received, wherein each of said end caps has an inner surface engageable with an outer end of said cutter when said second end cap is attached to said sleeve, whereby axial movement of said sleeve is restricted by said end caps to maintain said sleeve over said cutter.

11. The kitchen utensil of claim 10, wherein said fastener includes an internal thread formed on one end of said sleeve and an external thread formed on a portion of said end cap.

12. The kitchen utensil of claim 11, wherein said second end cap includes a flange extending inwardly from said end cap, said external thread being formed on said flange such that said flange is threadably received within said internal thread formed on said sleeve.

13. The kitchen utensil of claim 12, wherein said flange has an inner surface defining a barrel opening to receive a portion of the cutter therein when said end cap is attached to said sleeve.

14. The kitchen utensil of claim 10 wherein said cutter defines inwardly extending handle recesses, and each handle includes an inwardly extending boss received in said handle recesses, wherein said cutter is rotatably fixed on said bosses.
